(19) United States
(12) Patent Application Publication
(10) Pub. No.: US 2025/0384113 A1
(43) Pub. Date: Dec. 18, 2025

(54) UNLOCKING ELECTRONIC DEVICE WITH FACIAL RECOGNITION USING 2D CAMERA IN DARK ENVIRONMENTS

(71) Applicant: MOTOROLA MOBILITY LLC, WILMINGTON, DE (US)

(72) Inventors: RANJEET GUPTA, AURORA, IL (US); RAKSHIT KHOSLA, HAWTHORN WOODS, IL (US); BINSHENG QUE, XIAMEN CITY (CN)

(21) Appl. No.: 18/758,188

(22) Filed: Jun. 28, 2024

Related U.S. Application Data
(63) Continuation of application No. PCT/CN2024/098969, filed on Jun. 13, 2024.

(51) Int. Cl. G06F 21/32; G06V 40/16; H05B 45/10; H05B 47/11

(52) U.S. Cl. CPC G06F 21/32; G06V 40/169; H05B 45/10; H05B 47/11

(57) ABSTRACT

An electronic device, method, and computer program product enables 2D camera capture of a facial image for login authentication while the device is in a dark environment. The method includes detecting an unlock trigger event while the device is in a locked state, and detecting, using a light sensor, a LUX value of ambient light in a space around the electronic device. In response to the LUX value of ambient light being below a threshold LUX value required to support 2D facial recognition, a light source of the device is activated to project light into the field of view of a camera of the device, to increase the LUX value of light detectable from an image captured within the camera's field of view. The camera is activated to capture the image, and the electronic device is unlocked, in response to the captured image matching a stored authentication image.

### PRIORITY APPLICATION

This application claims priority to International Application No. PCT/CN2024/098969 filed Jun. 13, 2024, the contents of which are fully incorporated herein by reference.

### BACKGROUND

### 1. Technical Field

The present disclosure relates generally to electronic devices with displays and 2D cameras, and in particular to communication devices with displays and 2D cameras used for secure authentication of a user.

### 2. Description of the Related Art

Biometric authentication has become one convenient method to provide a user of an electronic device with the ability to unlock his/her device with the use of a fingerprint or a facial image, e.g., via facial recognition. Portable electronic devices, particularly smartphones, have been used to store personal information, such as email and text communications, captured photographic images, and access logins to applications and services, including financial services. In order to protect access to this personal information and to prevent unauthorized access to the various content on the electronic devices, a user login authentication process can be configured on the device. The login authentication process involves the device automatically locking access to the user interface (presented on the display) after a period of non-use of the device or when the device is manually put into a sleep mode or is manually turned off. Similarly, non-portable electronic devices, such as a door camera, can often be installed and used to provide secure physical access to a structure or locked environment via use of biometric authentication.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of an electronic device having a display which can be transitioned from a darkened (off/non-luminous) state to brightened (luminous) stated to support capturing of an image located in front of the display in a low light or dark environment, according to one or more embodiments;

FIG. 2 depicts a functional block diagram of the electronic device of FIG. 1 configured for operating as a communication device within a communication environment, according to one or more embodiments;

FIGS. 3A-3E presents a sequence of views of the display of the electronic device within a low light or dark environment with the display transitioning from a non-luminous state to a fully luminous state to support capture of a login authentication image by a 2D camera to provide access to the electronic device, according to one or more embodiments;

FIG. 4 depicts an example of a lift to view (LTV) movement of an electronic device 100 that activates the process for enabling a controller of the electronic device to implement a granular increase of an amount of projected light from a front facing light source into a field of view of the 2D camera when the electronic device is in a low light or dark environment, according to one or more embodiments;

FIGS. 5A-5C depict a foldable electronic device that is activated to initiate image-based login authentication based on sensors detecting the device being unfolded in a low light or dark environment, according to one or more embodiments;

FIGS. 6 and 7 depict a dual sided electronic device having both a front and a back display and front and back light sources that enable selective front or back activation of the image-based login authentication in a low light or dark environment, based on a positioning of the user relative to the front or the back 2D camera, according to one or more embodiments;

FIG. 8 is a flow diagram of a method for performing image-based user login authentication in a low light or dark environment using 2D cameras and granularly increasing device-provided lighting, according to one or more embodiments;

FIG. 9 is a flow diagram presenting a method of gradually increasing the intensity of a backlight of a display to enable capture by the 2D camera of a discernible image that is utilized for image-based login authentication for the electronic device, according to one or more embodiments; and

FIG. 10 is a flow diagram presenting a method of selectively activating a front or a back backlight and corresponding front or back camera to effect the image-based login authentication of a user based on a determined position of the user relative to the front or back of the electronic device, according to one or more embodiments.

### DETAILED DESCRIPTION

According to aspects of the present disclosure, an electronic device, a method, and computer program product enables 2D camera capture of a facial image for login authentication while the device is in a low light or dark environment. Specifically, the disclosure supports image-based login authentication to the device by a user while the device is in a low light or dark environment by modulating the backlight of the display or other light source of the device to enable capture of a usable/discernible image by a 2D camera. In one or more embodiments, the method includes detecting an unlock trigger event while the device is in a locked state, and detecting, using a light sensor, a LUX value of ambient light in a space around the electronic device. In response to the LUX value of ambient light being below a threshold LUX value required to support 2D facial recognition, a light source of the device is activated to project light into the field of view of a camera of the device, to increase the LUX value of light detectable from an image captured within the camera's field of view. The camera is activated to capture the image, and the electronic device is unlocked, in response to the captured image matching a stored authentication image.

Mobile phones and other personal electronic devices can be configured to use facial recognition as the mechanism for authenticating the user before providing the user with login access to the device. A facial recognition system is a technology capable of matching a human face from a digital image or a video frame against a database of faces. Such a system is typically employed to authenticate users through ID verification services, and works by pinpointing and measuring facial features from a given image. There are two existing solutions for facial recognition or face authentication, based on the given hardware. The first solution is the Face 3D solution, whereby the device hardware includes 3D sensors (e.g., infrared sensors (IR) or time of flight (ToF) sensors). The second solution is the Face 2D solution, whereby the device hardware consists of an RGB camera and does not have any 3D sensors, such as IR or ToF. Implementing these 3D sensors adds an extra cost to the device, so is not a standard across a majority of devices, which instead rely on the Face 2D solution. Importantly, implementing the facial recognition process with the Face 2D solution (i.e., using a 2D camera) requires the facial image being capture be exposed to sufficient light to enable the device's camera to capture an image with sufficient clarity for the facial features to be recognizable for matching with a stored image. Consequently, conventional devices that provide only the Face 2D solution are not able to use facial recognition when the device is in a low ambient light condition, such as during the night when the surroundings are dark. Users of these devices therefore have had to resort to a manual process of login into his/her device whenever in such low light or dark environments.

Aspects of the present disclosure address and overcome this limitation with devices that provide 2D image capture to authenticate a user of the electronic device while in a low light or dark ambient environment. It is appreciated that references to a low light or dark ambient environment includes an environment that can include some amounts of light, but not enough light to allow the 2D cameras to be able to capture an image that can be used to perform the image-based login authentication processes. Accordingly, the terms low light environment or dark environment are/can be used interchangeably and are assumed to include from pitch black to variances in the amount of light available, below a threshold amount of light required to enable image-based login authentication. One or more embodiments provide an electronic device having at least one display and at least one light source that can be controlled to project light in a direction away from a surface of the electronic device and whose light intensity can be granularly modified. The electronic device has at least one camera that captures one or more images within a field of view when a corresponding one of the at least one camera is activated and a memory having stored thereon program code comprising an image recognition authentication (IRA) module. The electronic device also includes a controller communicatively coupled to the at least one display, the at least one light source, the at least one camera, and the memory. The controller is configured to cause the electronic device to detect an unlock trigger event while the electronic device is in a locked state, the unlock trigger event activating the facial recognition authentication module which configures the electronic device to perform image recognition to unlock the electronic device. The controller causes the electronic device to detect a LUX value of ambient light in a space in which the electronic device is located. In response to the LUX value of the ambient light being below a threshold LUX value required to support 2D facial recognition, the processor causes the electronic device to: activate the light source of the electronic device to project light into the field of view of the at least one camera, the projected light increasing the LUX value of light detectable from an image captured within the field of view; activate the corresponding one of the at least one camera to capture the image within the field of view; and unlock the electronic device for access by a user, in response to the captured image matching a stored image of an authentication token for the electronic device.

Accordingly, among the benefits of the disclosure is the ability to configure existing electronic devices that include 2D cameras for Face 2D authentication solutions to be able to perform the face authentication while the device is located in a low light or dark ambient environment. Another benefit is the reduced cost of the device, where no special 3D sensors are required to enable facial authentication features to be provided while the device is in such low light or dark ambient environments.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

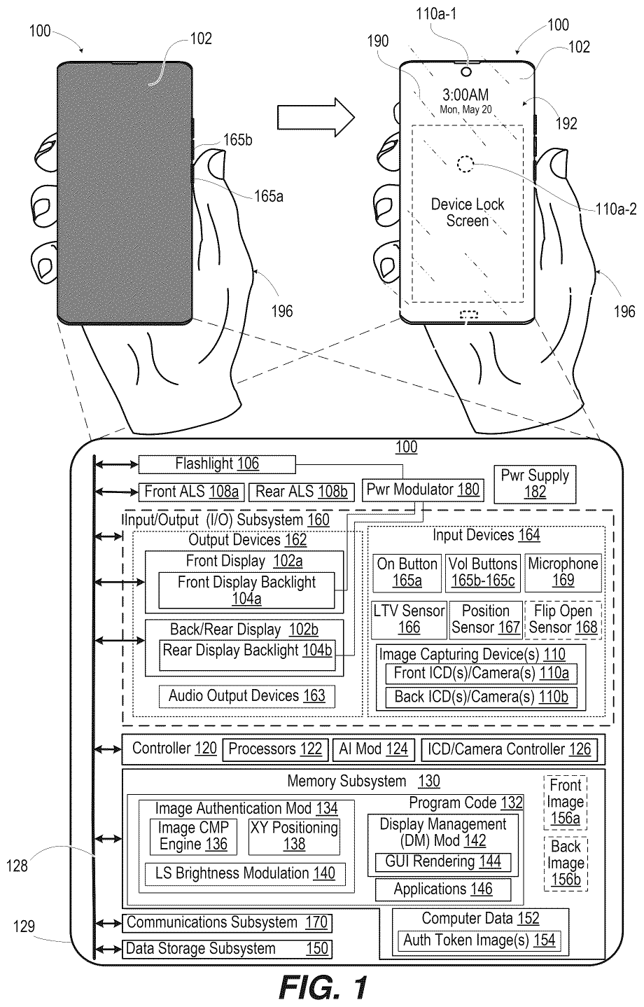

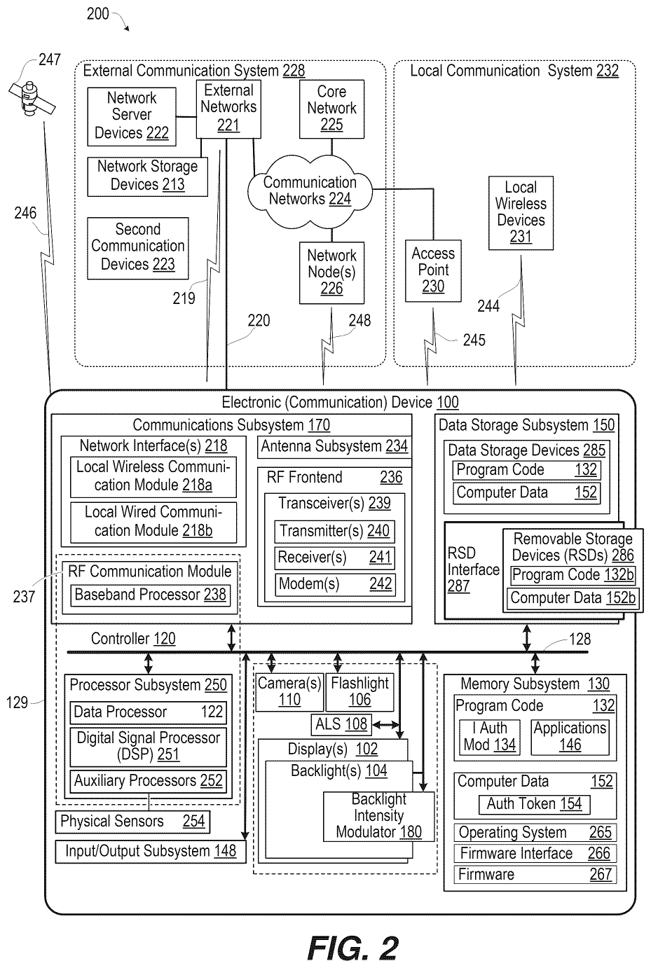

FIG. 1 presents a functional block diagram of an electronic device having a display that gradually transitions from a darkened (off/non-luminous) state to brightened (luminous) stated to support capturing of an image located in front of the display in a dark ambient environment, according to one or more embodiments. FIG. 2 depicts a functional block diagram of the electronic device of FIG. 1 configured for operating as a communication device within a communication environment, according to one or more embodiments. Electronic device 100 and electronic/communication device 100 present example devices within which the features of the present disclosure are advantageously implemented. For simplicity, both illustrated devices will be described together as electronic device 100 with similar components having the same reference numerals and described only once for electronic device 100 (FIG. 1).

Physical and logical components of FIG. 1 are presented in the lower block diagram, while the display transition from a dark screen to a bright screen are presented in the upper hand-held device figures, which illustrate the front display of electronic device transitioning from an off state to an on state with light rays projected from a surface therefrom. With reference to FIG. 1, electronic device 100 includes device housing 129 having front side and back side opposed to the front side and a left and right edge or side. Electronic device 100 includes at least one display 102a-102b and at least one light source 104a-104b, 106 that can be controlled to project light (rays 190) in a direction away from a (display) surface 192 of the electronic device 100 and whose light intensity can be granularly modified. In one embodiment, the granular modification of the projected light intensity is performed via controller 120 executing light source brightness modulation module 140 to control a power modulator 180 attached to an input power source 182 and to the corresponding one of the at least one light source 104a-104b, 106. In one or more embodiments, where the light source is the display's backlight, the power modulator 180 is or can be referred to as the backlight intensity modulator 180 (see FIG. 2). The at least one display includes at least one front display 102a located at/embedded within a front side of the device housing 129 and can include at least one back/rear display 102b located at/embedded within the rear side of the device housing 129. The at least one light source includes one or more of front display backlight 104a, read display backlight 104b, and flashlight 106, each of which are coupled to power modulator 180, which can be a different modulator or mechanism for granularly adjusting the intensity for each light source.

Electronic device 100 has at least one camera (or image capturing device, ICD) 110 that captures one or more images within a field of view of the selected camera when the corresponding one of the at least one camera 110 is activated. The at least one camera 110 can include both front cameras 110a and back/rear cameras 110b, which are collectively referred to as at least one camera 110. The cameras can be activated for operation to capture one or more images or video by camera controller 126 or generally controller 120 of the electronic device 100.

Electronic device 110 includes a memory (or memory subsystem) 130 having stored thereon program code 132 that includes an image recognition authentication (or image authentical) module 134, which in one or more embodiments is synonymous with and provides the functions of a facial recognition module. In the illustrated embodiment, image authentication module 134 includes an image comparison engine 136, which can include use of artificial intelligence (AI), and XY positioning module 138 for signaling a user to adjust the relative position of the image within the field of view of and ideal distance from the active camera. Image authentication module 134 also includes light source (LS) brightness modulation code 140 for triggering the controller to perform the modulation of the light source based on feedback received from the controller's execution of image comparison engine 136. Program code 132 also includes (front and back) display management application 142, which includes GUI rendering code 144. In one or more embodiments, one or more of the functions supported by the various program code can be provided via device firmware or operating system. It is appreciated that display management application 142 can support just a front display for a single display device. Program code 132 can further include one or more applications 146 that provide the user interactive features accessed on the electronic device 100.

Memory subsystem 130 also includes computer data 152 that includes authentication token images 154. It is appreciated that computer data 152 and other modules described as residing within memory or memory subsystem 130 can be stored in data storage subsystem 150, which is persistent device storage. According to one or more embodiments, authentication token images 154 incudes picture images of one or more users that are authorized to access the electronic device 100 by presenting their respective face for performing facial recognition during device activation or login. It is appreciated that authentication token images 154 can include other images other than a human face that is being used to enable image recognition-based login authentication. As an example, a particular 3D object, such as a bust or pendant can potentially be set up as an authentication token that has to be physically presented within the field of view of the active camera with sufficient light for the object to be recognized as a match to the stored image (154) of the object. Camera captured images (155) which are captured during image-based login authentication can be stored in memory as one of front image 156a or back image 156b, in different embodiments.

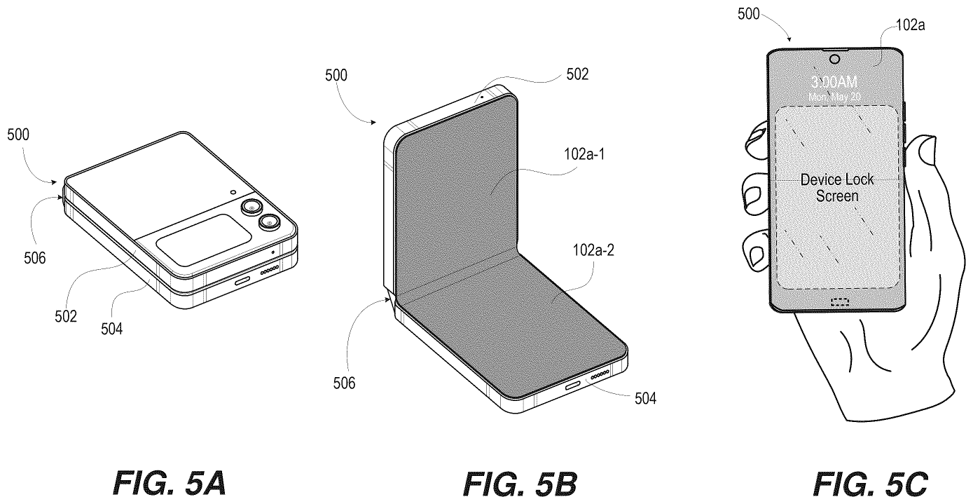

Electronic device includes input/output subsystem 160, which includes output devices 162, such as displays 102 and audio output devices 163 (e.g., speakers), and input devices 164. IN addition to a visual screen, which is an example of output device 162, displays 102 can include a touch screen interface, which is also considered as an input device (164). Included in input devices 164 are external buttons 165 (which includes on button 165a to activate the device from a sleep or off state and volume buttons 165b to manually control the device's audio volume. Also included in input devices 164 are lift to view (LTV) sensor 166, optional position/orientation sensor 167, optionally flip open (housing rotation) sensor 168, and microphone 169. LTV sensor 166 detects when the electronic device is being lifted from a horizontal state up to a (partially) vertical state to align the display within the viewing angle of a user's eyes/face. Position/orientation sensor 167 can enable a dual display device to determine whether the user is facing the front display 102a or the rear display 102b of electronic device 100. Flip open sensor 168 is present when the electronic device 100 is configured as a flip phone (as shown in FIGS. 5A-5C) and signals the controller of the opening of the device housing whenever flip open sensor 168 detects the opening of the device housing 129 from a closed state to an open state. In one embodiment, output devices 162 can be described to include flashlight 106, and input device can be described to include front and rear ambient light sensors 108a-108b.

Electronic device 100 also includes controller 120 communicatively coupled, via system interconnects/interlinks 128 (indicated using connecting lines with bi-directional arrows), to the at least one display 102, the at least one light source 104a-104b, 106, the at least one camera 110, and the memory or memory subsystem 130. System interconnects/interlinks 128 communicatively connects controller 120 with each of the other controllable components of electronic device to enable device management by controller 120. System interconnects/interlinks 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIGS. 1-2, it is to be understood that more, fewer, or different interconnections may be present in other embodiments.

As illustrated, controller 120 can include one or more processors 122, an AI engine/module 124 and camera controller 126, among other controller components, such as a digital signal processor (DSP), illustrated in FIG. 2. The controller 120 is configured via hardware configuration and execution of the various program code 132 and in particular code for the image authentication module 134 to cause the electronic device 100 to perform the various features of the disclosed embodiments, as presented herein. In particular, the controller 120 is configured to cause the electronic device 100 to detect an unlock trigger event while the electronic device 100 is in a locked state. The unlock trigger event activates the facial recognition authentication module (134) which configures the controller 120 to cause the electronic device 100 to perform image recognition to unlock the electronic device 100. In one or more embodiments, to detect the unlock trigger event, the controller receives an input from a physical button (165a) of the electronic device 100 that is depressed to trigger activation and unlocking of the electronic device 100.

The controller 120 causes the electronic device 100 to detect a LUX value of ambient light in a space in which the electronic device is located. In one or more embodiments, the electronic device 100 includes an ambient light sensor (ALS) 108 communicatively coupled to the controller 120 and which performs the detection of the LUX value of the ambient light and transmits the detected LUX value to the controller 120, and the controller 120 performs the comparison with the threshold LUX value. In response to the LUX value of the ambient light being below a threshold LUX value required to support 2D facial recognition, the controller 120 causes the electronic device to: activate the light source (104a/104b/106) of the electronic device 100 to project light into the field of view of the at least one camera 110, the projected light increasing the LUX value of light detectable from an image captured within the field of view; activate the corresponding one of the at least one camera 110 to capture the image within the field of view; and unlock the electronic device 100 for access by a user, in response to the captured image matching a stored image of an authentication token (154) for the electronic device 100.

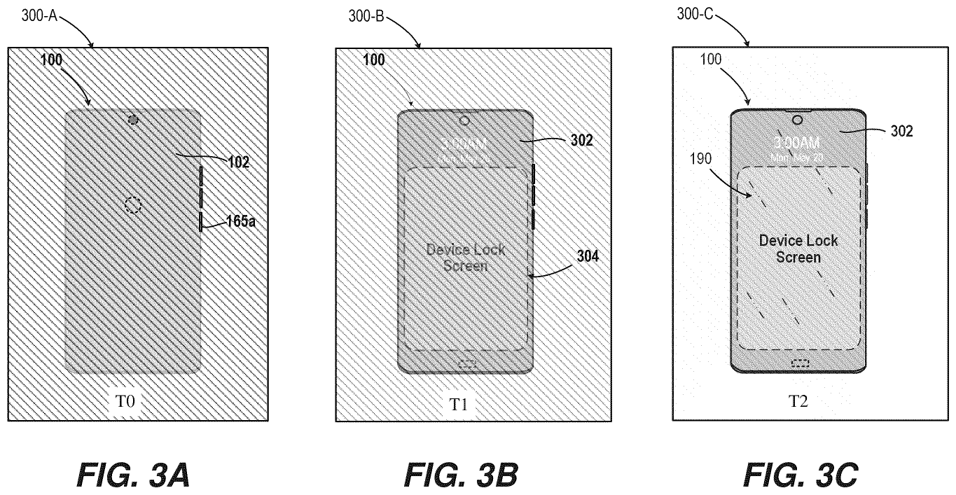

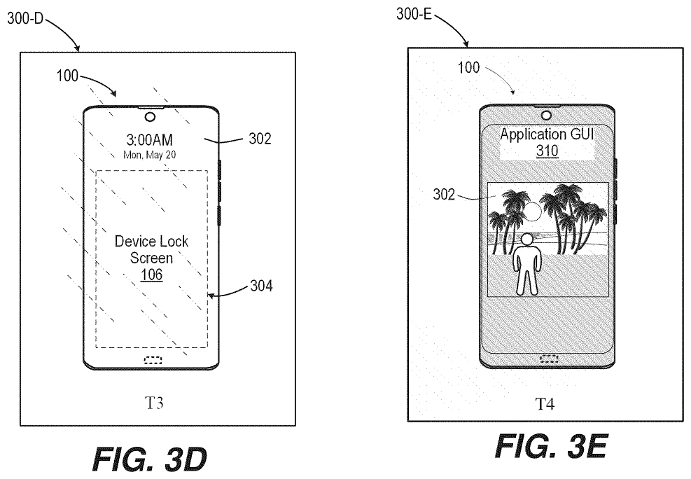

Accordingly, as shown by the upper hand-held device figures, display 102 of electronic 100 being held by users hand 196 transitions from a dark/off state to a lucent/luminous bright state. Notably, the trigger illustrated by FIG. 1 is the user depressing on button 165a. Further, while not obvious from the figures, an assumption is made that the electronic device is located in a low light or dark ambient environment and that the transition of the device display 102 to the lucent/luminous/bright state is a gradual transition (as presented by FIGS. 3A-3D). The right upper figure further presents both a standard front camera 110a-1 and a camera under display (CUD) 110a-2 as two different front camera options. Also, light rays 190 are illustrated being projected from display surface 192.

In one or more embodiments, the at least one light source includes a backlight of the display, and the controller activates the backlight at a low luminance level and gradually increases a luminance of the backlight to increase a brightness of the display until an amount of light projected enables capture of the image with sufficient clarity to complete the image recognition for login authentication. In one or more alternate embodiments, the at least one light source includes a flashlight, and the controller activates the flashlight at a low luminance level and gradually increases a luminance of the flashlight to enable capture of the image with sufficient clarity to complete the image recognition for login authentication.

According to one or more embodiments, to detect the LUX value of ambient light in the surrounding environment/space, the camera controller 126 activates a lens of at least a first camera among the at least one camera to operate as a light sensor by opening and receiving an impingement of light from the surrounding space. The controller 120 or camera controller 126 then identifies the LUX value based on an amount of impingement of light received at the lens of the first camera.

FIG. 1 presents the functional components of electronic device, which includes controller 120, memory subsystem 130, data storage subsystem 150, and input/output (I/O) subsystem 160. To support electronic device 100 further operating as a communication device, electronic device 100 also includes communication subsystem 170. FIG. 2 depicts a functional block diagram of the electronic device of FIG. 1 configured for operating as a communication device (100) within a communication environment 200 that supports wireless communication, according to one or more embodiments. Similar elements are provided with the same reference number and are thus not all described in the description of FIG. 2.

As a communication device, electronic device 100 can be one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. As a device supporting wireless communication, electronic/communication device 100 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices connected to a wireless modem.

In one or more embodiments, communications subsystem 170 may include one or more network interfaces 218, such as local wireless communication module 218a and local wired communication module 218b, to communicatively couple communication device 100 via wireless connection 219 or network cable 220, respectively, to external networks 221. For example, wireless connection 219 and network cable 220 can be an Ethernet connection/cable. Communication device 100 may connect, via external networks 221, to network storage devices 213 that store computer data and to network server devices 222 that facilitate access to network storage devices 213. Network server devices 222 may have identical or similar components and functionality as described above for electronic device 100. Electronic device 100 may communicate with second communication devices 223 via external networks 221 or via communication networks 224 that are supported by core networks 225. Network interface(s) 218 may include a network interface controller (NIC) and support one or more network communication protocols. External networks 221 can include a local area network (LAN), a campus area network (CAN), a metropolitan area network (MAN), or a wide area network (WAN).

In one or more embodiments, communications subsystem 170 may include additional functionality for communicating, using a cellular connection, with network node(s) 226 of external communication system 228 and for communicating, using a wireless connection, with wireless access point 230 or local wireless devices 231 of local communication system 232.

Communications subsystem 170 includes antenna subsystem 234. Communications subsystem 170 includes radio frequency (RF) front end 236 and RF communication module 237 having baseband processor 238. RF front end 236 includes transceiver(s) 239, which includes transmitter(s) 240 and receiver(s) 241. RF front end 236 further includes modem(s) 242. Baseband processor 238 of RF communication module 237 communicates with controller 120 and RF front end 236. Baseband processor 238 operates in a baseband frequency range to encode data for transmission and decode received data, according to a communication protocol. Modem(s) 242 modulates baseband encoded data from RF communication module 237 onto a carrier signal to provide a transmit signal that is amplified by transmitter(s) 240. Modem(s) 242 demodulates each signal received using antenna subsystem 234 from external communication system 228 or local communication system 232. The received signal is amplified and filtered by receiver(s) 241, which demodulates received encoded data from a received carrier signal.

In one or more embodiments, controller 120, via communications subsystem 170, performs multiple types of cellular over-the-air (OTA) or wireless communication with local communication system 232. Communications subsystem 170 can communicate via an OTA connection 244 with local wireless devices 231. In an example, OTA connection 244 is a Bluetooth connection, or other personal access network (PAN) connection. In one or more embodiments, communications subsystem 234 communicates with one or more locally networked devices via a wireless local area network (WLAN) link 245 supported by access point 230. In one or more embodiments, access point 230 supports communication using one or more IEEE 802.11 WLAN protocols. Access point 230 is connected to communication networks 224 via a cellular or wired connection. In one or more embodiments, communications subsystem 170 receives downlink channels 246 from GPS satellites 247 to obtain geospatial location information. Communications subsystem 170 can communicate via an over-the-air (OTA) cellular connection 248 with network node(s) 226.

Controller 120 includes processor subsystem 250, which includes one or more central processing units (CPUs), depicted as data processor 122. Processor subsystem 250 can include one or more digital signal processors 251 that can be integrated with data processor 122. Processor subsystem 250 can include other processors that are communicatively coupled to data processor 122, such as baseband processors 238 of communication module 237. In another example, auxiliary processors 252 may act as a low power consumption, always-on sensor hub for physical sensors 254. Physical sensors 254 is a catch all for multiple different sensors that can be provided within electronic device 100. FIG. 1 presents several examples of physical sensors 254, including, without limitation, ALS 108, LTV sensor 166, and position/orientation sensor 167. In one or more embodiments that are not depicted, controller 120 can further include distributed processing and control components that are external to device housing 129 or grouped with other components, such as I/O subsystem 160. Data processor 122 is communicatively coupled, via system interlink 128, to memory subsystem 130. In one or more embodiments, data processor 122 is communicatively coupled via system interlink 128 to communications subsystem 170, data storage subsystem 150, and I/O subsystem 160. Controller 120 manages, and in some instances directly controls, the various functions and/or operations of communication device 100. These functions and/or operations include, but are not limited to including, application data processing, communication with second communication devices, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory subsystem 130 stores program code 132 for execution by processor subsystem 250 to provide the functionality described herein. Program code 132 includes applications such as Image Authentication Module 134 that initiates the processes of the disclosure. Program code 132 may include other applications 146. In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner. Implementation of program code 132 may use any known mechanism or process for doing so using integrated hardware and/or software, as known by those skilled in the art. Program code 132 may access, use, generate, modify, store, or communicate computer data 152, such as authentication token image(s) 154.

Memory subsystem 130 further includes operating system (OS) 265, firmware interface 266, such as basic input/output system (BIOS) or Uniform Extensible Firmware Interface (UEFI), and firmware 267, which may be considered as program code 132.

Data storage subsystem 150 of electronic device 100 includes data storage device(s) 285. Controller 120 is communicatively connected, via system interlink 128, to data storage device(s) 285. Data storage subsystem 150 provides program code 132 and computer data 152 stored on nonvolatile storage that is accessible by controller 120. For example, data storage subsystem 150 can provide a selection of program code 132 and computer data 152. These applications can be loaded into memory subsystem 130 for execution/processing by controller 120. In one or more embodiments, data storage device(s) 285 can include hard disk drives (HDDs), optical disk drives, and/or solid-state drives (SSDs), etc. Data storage subsystem 150 of electronic device 100 can include removable storage device(s) (RSD(s)) 286, which is received in RSD interface 287. Controller 120 is communicatively connected to RSD 286, via system interlink 162 and RSD interface 287. In one or more embodiments, RSD 286 is a non-transitory computer program product or computer readable storage device. Controller 120 can access data storage device(s) 285 or RSD 286 to provision electronic device 100 with program code 132/132b and computer data 152/152b.

Accordingly, one or more embodiments provides a computer program product that includes: a non-transitory computer readable storage device; and program code on the computer readable storage device that when executed by a controller associated with an electronic device. The program code configures the controller to cause the electronic device to provide functionality described herein. Specially, the device is caused/configured to detect: an unlock trigger event while an electronic device is in a locked state, the unlock trigger event activating the facial recognition authentication module which configures the electronic device to perform image recognition to unlock the electronic device; detect, using a light sensor, a LUX value of ambient light in a space in which the electronic device is located. The program code further configures the processor to perform the functions of, in response to the LUX value of the ambient light being below a threshold LUX value required to support 2D facial recognition: activating a light source of the electronic device to project light into the field of view of at least one camera of the electronic device, the projected light increasing the LUX value of light detectable from an image captured within the field of view; activating a first one of the at least one camera to capture the image within the field of view; and unlocking the electronic device for access by a user, in response to the captured image matching a stored image of an authentication token for the electronic device.

According to one embodiment, the light source comprises a backlight of the display and the program code configures the controller to cause the electronic device to provide the functionality of activating the backlight at a low luminance level and gradually increasing a luminance of the backlight to increase a brightness of the display until an amount of light projected enables capture of the image with sufficient clarity to complete the image recognition for login authentication.

It is appreciated that while the described embodiments of an electronic device 100 are presented with specific reference to a mobile device (100) and the user gaining login access to operate and access application and data content within the mobile device, aspects of the disclosure are applicable to non-portable electronic device, such as image-based electronic locking systems that also rely on having sufficient ambient lighting to allow for image capturing by an integrated or connected 2D camera to enable opening of the locking mechanism. As an example, an electronic lock can be provided at a home and configured to unlock when the homeowner's face is detected with sufficient light to allow the captured image to be used to complete a comparison with a stored image of the homeowner's face. The described features can therefore be applied to this and other examples of non-portable electronic devices with image-based authentication via 2D cameras.

FIGS. 3A-3E presents a sequence of views of the display of the electronic device 100 within a low light or dark environment with the device display transitioning from a non-luminous state to a fully luminous state to support capture of a login authentication image by a 2D camera to provide access to the electronic device, according to one or more embodiments. Electronic device includes at least one camera 110, which are indicated as front camera 110a-1 and CUD 110a-2. Beginning at FIG. 3A, electronic device 100 is shown in a dark environment 300A, with relative darkness being indicated by the hash marks and amount of visibility in the dark environment 300A to see the outline of electronic device 100. Electronic device 100 is shown with display screen 102 off at time TO, which is prior to activation of the device for image-based login authentication. At time T1 (FIG. 3B), electronic device 100 is activated and the device lock screen 304 is presented on the moderately lit display screen 302. The process for image-based login authentication is also initiated; however, the ambient environment 300B is too dark for the 2D camera to capture an image with enough clarity (luminance) to enable the captured image to be used for the authentication process. Accordingly, the controller 120 operates in the background to granularly increase the intensity of the selected light source, which is the display backlight, in this illustration. At time T2 (FIG. 3C), the light intensity is increased and the projected light rays 190 increases the visibility of the surrounding space (300C). The amount of light is still insufficient for the 2D authentication to be effective, and the controller increases the light intensity even more as shown at FIG. 3D where the light rays 190 are shown extending even further from the display screen 302 at time T3. At this level of light intensity, the object placed in front of the display is sufficiently illuminated for the captured image to be analyzed by the image comparison engine 136 (FIG. 1), enabling the controller 120 to complete the authentication process. At time T4 (FIG. 3E), the captured image has been authenticated, and the controller provides access to the applications 310 and other graphical user interfaces accessible on the electronic device 100. Also, at time T4, controller 120 rolls back the intensity of the light source to a base level, such that the amount of light generated and projected by the light source is not as bright as when the light source is being utilized to illuminate the object whose image is being captured in the low light or dark environment (300A). Accordingly, in one or more embodiments, following completion of the capture of the image, the controller 120 reduces a level of the light source back to an initial level from before initiation of the image recognition authentication, adjusted for the level of light customary for the device in the present ambient setting and based on the graphic/video representations being presented on the display screen.

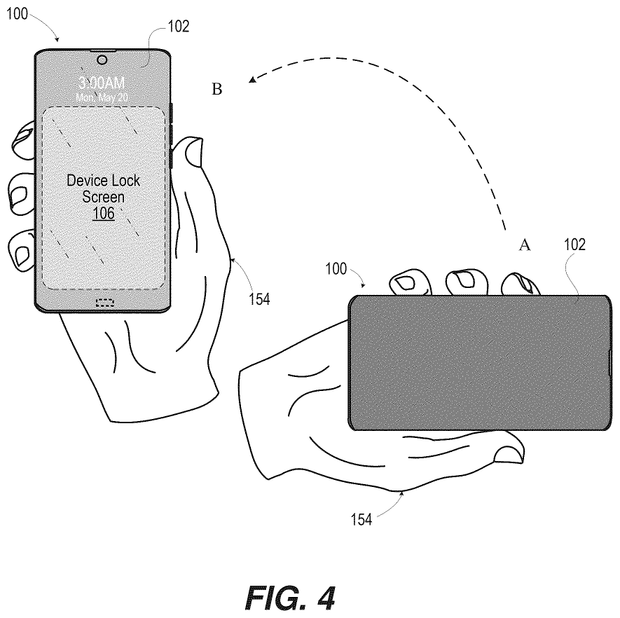

FIGS. 4 and 5A-5C illustrate examples of alternate triggers that can activate the image-based login authentication processes described herein. Specifically, FIG. 4 depicts an example of a lift to view (LTV) movement of an electronic device 100 that activates the process for enabling a controller 120 of the electronic device 100 to implement a granular increase of an amount of projected light from a front facing light source into a field of view of the 2D camera when the electronic device 100 is in a dark environment, according to one or more embodiments. In FIG. 4, electronic device 100 is being held in a user's hand 196 and is being rotated or lifted from a lowered position A to an upright facing position B at which a user can view and interact with the display screen 102 of electronic device 100. Position/orientation sensor 167 detects the movement of the electronic device 100 into the upright facing position B and transmits a signal to the controller to activate (i.e., soft power on of the display from sleep mode) the electronic device 100 and initiated the image-based login authentication. Accordingly, the electronic device 100 further includes a movement sensor (166, FIG. 1) that detects movement associated with a lift to view of the electronic device 100, the movement sensor (166) communicatively connected to the controller 120, where the controller 120 detects the unlock trigger event based on receiving input from the movement sensor (166) indicating the electronic device is being moved into a display viewing position.

FIGS. 5A-5C depict a foldable electronic device that is activated to initiate image-based login authentication based on sensors detecting the device being unfolded in a dark environment, according to one or more embodiments. FIG. 5A illustrates foldable electronic device 500 in a closed (i.e., clamshell) shape during which the electronic device 500 is in a low power off (or sleep) state. Foldable electronic device 500 can be one representation of electronic device 100 and include similar components as electronic device of FIGS. 1 and 2. In FIG. 5A, external housing (129, FIG. 1) of foldable electronic device 500 incudes an upper housing portion 502 and a lower housing portion 504 connected at one end via a hinge mechanism 506, which supports rotation of each of the upper and lower housing portions 502, 504 relative to each other. FIG. 5B illustrates foldable electronic device 500 in a partially opened position with upper housing portion 502 moved into almost a 90-degree angle relative to lower housing portion 504 to expose an upper and lower sections of front display 102a-1 and 102a-2. Display is still in an off state, as further rotation beyond this state operates as the trigger to activate the device and initiate the image-based login authentication. FIG. 5C then presents foldable electronic device 500 in a fully opened state at which the activation of the device has occurred and the process for completing the image-based login authentication using the 2D cameras has been initiated. While not specifically shown to be located in a dark environment, foldable electronic device 500 is assumed to be in a dark ambient environment in order to trigger the processes described herein when activation of the device is triggered by opening the housing of the foldable electronic device 500 beyond a certain degree of rotation, as detected by flip open/rotation sensor 168 (FIG. 1). Accordingly, in one embodiment, the electronic device 100/500 is configured as a flip phone having two connected rotatable housings 502/504 that enable the electronic device 100/500 to be rotatable into a closed and an open position, and where the movement sensor is a flip open/rotation sensor 168 that detects rotation of the rotatable housings to configured the electronic device into the open position, and the sensor (168) transmits a signal to the controller 120 that the controller 120 receives as the input indicating the electronic device is being moved into the display viewing position.

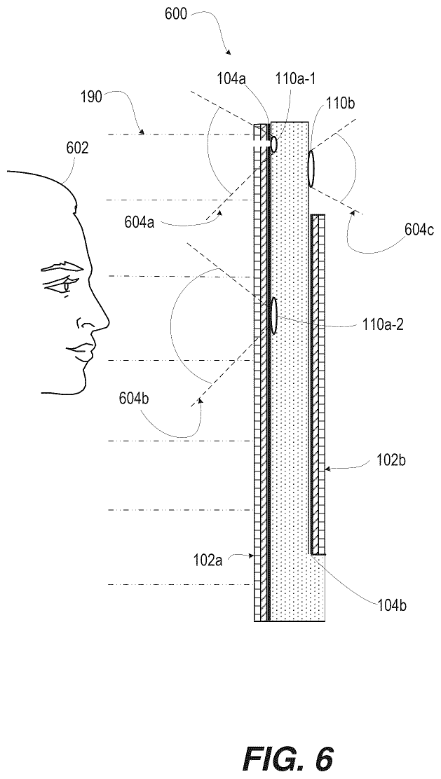

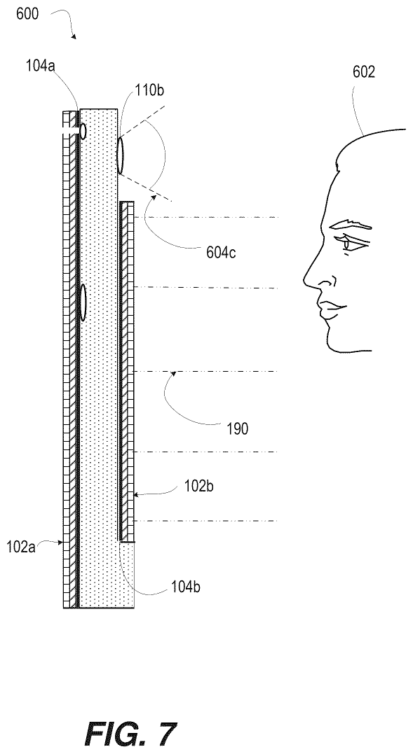

In one or more embodiments, the authentication token is an image of a face of an authenticated user, and the captured image is a face of a user attempting to access the electronic device. Further, the electronic device further includes a camera controller coupled to the at least one camera and the controller, where the camera controller is configured to initiate capture of an image within the field of view of the corresponding camera that is activated during a login authentication process that includes performing recognition of a captured image of a face. FIGS. 6 and 7 illustrate examples of a human face being presented in a space within the field of view of a camera and in front of the front and back display of an electronic device having front and back displays.

Turning now to the figures, FIGS. 6 and 7 depict a dual sided electronic device having both a front and a back display and front and back light sources that enable selective front or back activation of the image-based login authentication in a low light or dark environment, based on a positioning of the user relative to the front or the back 2D camera, according to one or more embodiments. According to one or more embodiments of electronic device 600 (which is described as being an implementation of electronic device 100 presented within FIG. 1), the at least one display includes a front (interior) display 102a and a back/rear (exterior) display 102b. Also, the at least one light source comprises at least one front light source (e.g., front display backlight 104a or flashlight 106) and at least one back light source (e.g., rear display backlight 104b). Further, the at least one camera comprises at least one front camera 110a and at least one back camera 110b, each having a respective field of view 604a, 604b, 604c. With this dual sided configuration, the controller: identifies, from received sensor inputs (i.e., position/orientation sensor 167), a position of a user 602 holding the electronic device, relative to a front and a back display 102a, 102b (or front or back side) of the electronic device 100. The controller 120 performs the gradual increase in light intensity of a selected light source that faces a location of the user 602 holding the electronic device 100, and the controller 120 selectively activates, to capture the image, a corresponding one of the at least one front camera 110a-1 or 110a-2 and the at least one back camera 110b that has a field of view directed at and capturing the position of the user 602. In FIG. 6, user 602 is positioned in front of front facing camera 110a of electronic device 100. The front facing camera 110a can be an upper embedded camera 110a-1 or a CUD 110a-2. The face of the user 602 receives light from the display screen 102b (i.e., the front backlight 104a) or from a front facing flashlight of the electronic device 100, and the light rays 190 impinges on and reflects off the user's face to allow for capture of an image of the user's face while/when the electronic device 100 is activated in a low light or dark ambient environment. Alternatively or inversely, in FIG. 7, the user 602 is positioned in front of rear facing camera 110b in the field of view 604c of rear facing camera 110b. The face of the user 602 receives light from the rear display screen 102b (i.e., the rear backlight 104b) or from a rear facing flashlight, and the light rays 190 impinges on and reflects off the user's face to allow for capture of an image of the user's face while/when the electronic device 100 is activated in a low light or dark ambient environment.

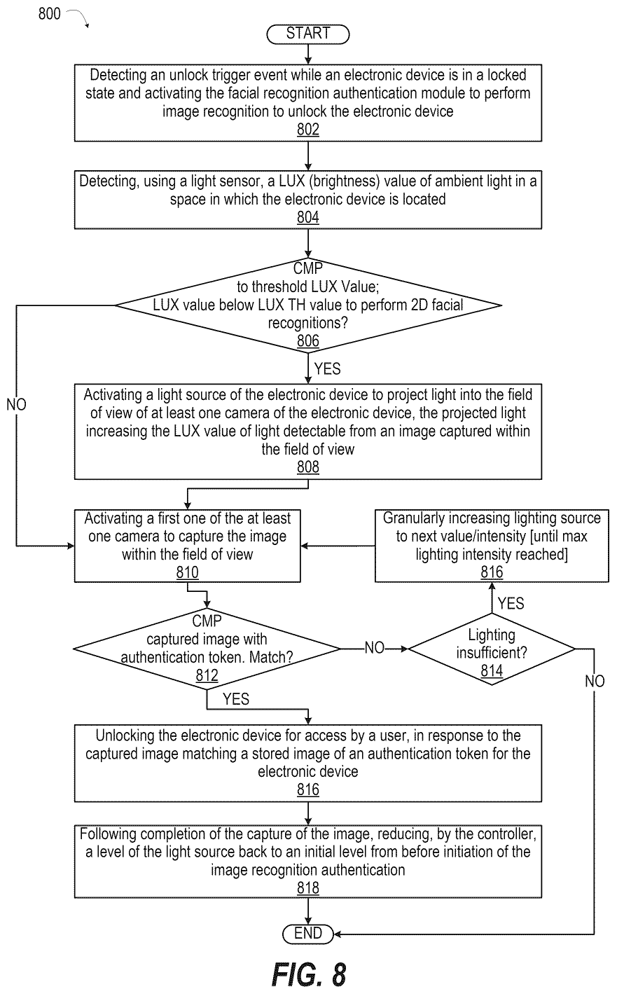

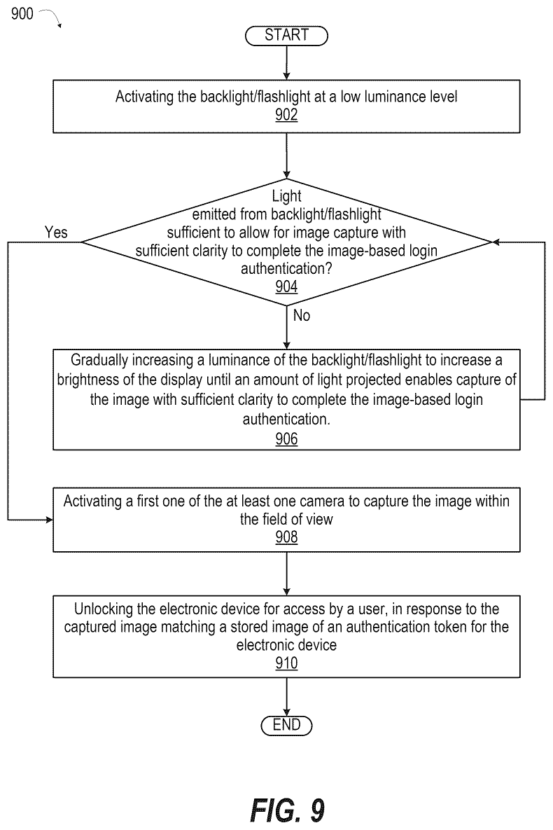

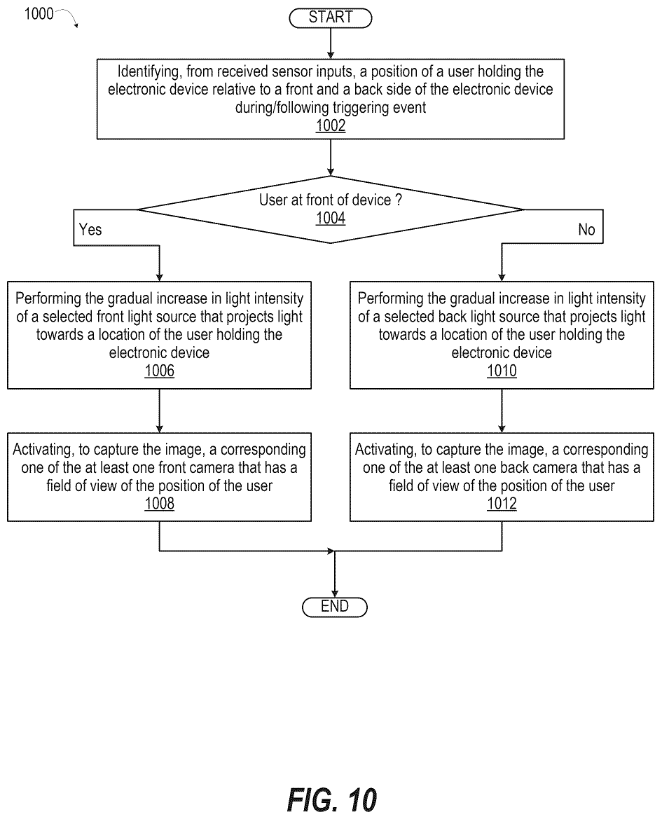

FIG. 8 is a flow diagram of a method for performing image-based user login authentication in a low light or dark environment using 2D cameras and granularly increasing device-provided lighting, according to one or more embodiments. FIG. 9 is a flow diagram presenting a method of gradually increasing the intensity of a backlight of a display to enable capture by the 2D camera of a discernible image that is utilized for image-based login authentication for the electronic device, according to one or more embodiments. FIG. 10 is a flow diagram presenting a method of selectively activating a front or a back backlight and corresponding front or back camera to effect the image-based login authentication of a user based on a determined position of the user relative to the front or back of the electronic device, according to one or more embodiments. The descriptions of method 800 (FIG. 8), method 900 (FIG. 9), and method 1000 (FIG. 10) are provided with general reference to the specific components illustrated within the preceding FIGS. 1-7. Specific components referenced in method 800 (FIG. 8), method 900 (FIG. 9), and method 1000 (FIG. 10) may be identical or similar to components of the same name used in describing preceding FIGS. 1-7. In one or more embodiments, controller 120 (FIGS. 1-2) configures communication device 100 (FIGS. 1-2) to provide the described functionality of method 800, method 900, and method 1000.

With reference to FIG. 8, following the start block, method 800 includes detecting an unlock trigger event while an electronic device is in a locked state, the unlock trigger event activating the facial recognition authentication module, which configures the electronic device to perform image recognition to unlock the electronic device (block 802). Method includes detecting, using a light sensor, a LUX value of ambient light in a space in which the electronic device is located (block 804). Method 800 includes comparing the detected LUX value with a threshold minimum LUX value and determining whether the detected LUX value is greater than or equal to the threshold minimum LUX value (decision block 806). According to one or more embodiment, the threshold minimum LUX value is empirically determined and established through testing with different light conditions for the particular camera model. That threshold minimum LUX value is then encoded within the image recognition algorithm provided with the OS (or applicable application) of the electronic device. In one embodiment, the AI engine 124 (FIG. 1) performs a tracking and evaluation of the different comparisons performed under different light conditions detected during actual use of the electronic device by the user, and the AI engine 124 can adjust the value of the threshold minimum LUX to be greater than or less than the preset value based on the level of success in performing the image recognition in different (dark) ambient lighting conditions that have to be enhanced using the processes described herein.

From decision block 806, in response to the LUX value of the ambient light being below a threshold LUX value required to support 2D facial recognition, method 800 includes activating a light source of the electronic device to project light into the field of view of at least one camera of the electronic device, the projected light (granularly) increasing the LUX value of light detectable from an image captured within the field of view (block 808). Method 800 also includes activating a first one of the at least one camera to capture the image within the field of view (block 810). Method 800 includes comparing the captured image with the stored authentication token, such as a store facial image and determining if the images match (decision block 812). When the images do not match method 800 includes determining at decision block 814 whether the images did not match because there is insufficient detail in the captured image due to insufficient ambient lighting. When there is insufficient ambient lighting, and assuming the light source has not been increased to its maximum intensity, method includes granularly increasing the light source to a next intensity level (block 816) before performing a recapture of the image at block 810.

Returning to decision block 812, in response to the captured image matching the stored image of an authentication token for the electronic device, method 800 includes unlocking the electronic device for access by a user (block 816). Following completion of the capture of the image that is sufficiently lit to complete the authentication process (ending with either a grant of access to the electronic device or a non-granting of access due to a failed match), method 800 then includes reducing a level of the light source back to an initial level from before initiation of the image recognition authentication (block 818). The reduction of the light source is tempered by the amount of light actually required by the presented graphical user interface of the unlocked device screen and potentially also tempered by the amount of ambient light in the space, depending on the device settings for low light operations. Then method 800 ends.

Referring now to FIG. 9, the method 900 presented applies for device configurations where the light source is/includes a backlight of the display as well as configurations where situations where the light source includes a flashlight. It is further contemplated that in or more embodiments, the ambient environment may be such that both light sources are activated and gradually increased to enable capture of the image by the 2D cameras. Method 900 includes activating the backlight/flashlight at a low luminance level (block 902). Method 900 includes determining at decision block 904 whether the light emitted from the backlight/flashlight is sufficient to allow for image capture with sufficient clarity to complete the image recognition for login authentication. Based on the amount of light emission not being sufficient to allow for successful completion of the authentication (matching) process, method 900 includes gradually increasing a luminance of the backlight/flashlight to increase a brightness of the display until an amount of light projected enables capture of the image with sufficient clarity to complete the image recognition for login authentication (block 906). The process then cycles back to block 904.

However, when the amount of emitted light is sufficient, as determined at decision block 904, method 900 includes activating a first one of the at least one camera to capture the image within the corresponding field of view (block 908). Method 900 then includes unlocking the electronic device for access by a user, in response to the captured image matching a stored image of an authentication token for the electronic device (block 910). Method 900 then ends.

In one or more embodiments, the authentication token is an image of a face of an authenticated user, and the captured image is a face of a user attempting to access the electronic device. Methods 800 and 900 then includes unlocking the electronic device for access by a user, in response to the captured image of the face of the user matching a stored image of the face of the authenticated user.

Referring to FIG. 10, following the start block, method 1000 includes identifying, from received sensor inputs, a position of a user holding the electronic device relative to a front and a back side of the electronic device during/following a trigger (device activation) event (block 1002). As presented by FIGS. 6 and 7, the electronic device 100 includes at least one front camera and at least one back camera and at least one front facing light source and at least one back facing light source. Method 1000 includes determining at block 1004 whether the user is at the front of the device. In response to the user being at the front of the device (i.e., user is facing the front display screen/cameras), method 1000 includes performing the gradual increase in light intensity of a selected light source (i.e., the front projecting light source) that faces the front location of the user holding the electronic device (block 1006). Method 1000 then includes, activating to capture the image, a corresponding one of the at least one front camera that has a field of view of the position of the user (block 1008). From decision block 1004, in response to the user being at the back of the device (i.e., user is not facing the front display screen/cameras, but instead facing the rear display screen/cameras), method 1000 includes performing the gradual increase in light intensity of a selected light source (i.e., the rear projecting light source) that faces the rear location of the user holding the electronic device (block 1010). Method 1000 then includes activating, to capture the image, a corresponding one of the at least one back camera that has a field of view of the position of the user (block 1012). Method 1000 then ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one display;
at least one light source that can be controlled to project light in a direction away from a surface of the electronic device and whose light intensity can be granularly modified;
at least one camera that captures one or more images within a field of view when a corresponding one of the at least one camera is activated;
a memory having stored thereon program code comprising an image recognition authentication (IRA) module; and
a controller communicatively coupled to the at least one display, the at least one light source, the at least one camera, and the memory, and which is configured to cause the electronic device to:
detect an unlock trigger event while the electronic device is in a locked state, the unlock trigger event activating the image recognition authentication module which configures the electronic device to perform image recognition to unlock the electronic device;
detect a LUX value of ambient light in a space in which the electronic device is located; and
in response to the LUX value of the ambient light being below a threshold LUX value required to support 2D facial recognition:
activate a light source among the at least one light source of the electronic device to project light into the field of view of the at least one camera, the projected light increasing the LUX value of light detectable from an image captured within the field of view;
activate the corresponding one of the at least one camera to capture the image within the field of view; and
unlock the electronic device for access by a user, in response to the captured image matching a stored image of an authentication token for the electronic device.

2. The electronic device of claim 1, wherein the at least one light source comprises a backlight of a display from among the at least one display, and the controller activates the backlight at a low luminance level and gradually increases a luminance of the backlight to increase a brightness of the display until an amount of light projected enables capture of the image with sufficient clarity to complete the image recognition for login authentication.

3. The electronic device of claim 1, wherein the at least one light source comprises a flashlight, and the controller activates the flashlight at a low luminance level and gradually increases a luminance of the flashlight to enable capture of the image with sufficient clarity to complete the image recognition for login authentication.

4. The electronic device of claim 1, further comprising an ambient light sensor (ALS) communicatively coupled to the controller and which performs the detection of the LUX value of the ambient light and transmits the detected LUX value to the controller, which performs a comparison with the threshold LUX value.

5. The electronic device of claim 1, wherein the authentication token is an image of a face of an authenticated user, and the captured image is a face of a user attempting to access the electronic device.

6. The electronic device of claim 1, further comprising a camera controller coupled to the at least one camera, wherein the camera controller is configured to initiate capture of an image within the field of view of the corresponding camera that is activated during a login authentication process that comprises performing recognition of a captured image of a face.

7. The electronic device of claim 6, wherein to detect the LUX value of ambient light, the camera controller: activates a lens of at least a first camera among the at least one camera to operate as a light sensor by opening and receiving an impingement of light from the surrounding space; identifies the LUX value based on an amount of impingement of light received at the lens of the first camera.

8. The electronic device of claim 1, wherein to detect the unlock trigger event, the controller receives an input from a physical button of the electronic device that is depressed to trigger activation and unlocking of the electronic device.

9. The electronic device of claim 1, further comprising a movement sensor that detects movement associated with a lift to view of the electronic device, the movement sensor communicatively connected to the controller, wherein the controller detects the unlock trigger event based on receiving input from the movement sensor indicating the electronic device is being moved into a display viewing position.

10. The electronic device of claim 9, wherein the electronic device is configured as a flip phone having two connected rotatable housings that enable the electronic device to be rotatable into a closed and an open position, and wherein the movement sensor detects rotation of the connected rotatable housings to configured the electronic device into the open position and transmits a signal to the controller that the controller receives as the input indicating the electronic device is being moved into the display viewing position.

11. The electronic device of claim 1, wherein:
the at least one display comprises a front display and a back or exterior display;
the at least one light source comprises at least one front light source and at least one back light source;
the at least one camera comprises at least one front camera and at least one back camera; and
the controller:
identifies, from received sensor inputs, a position of a user holding the electronic device relative to a front and a back side of the electronic device;
performs a gradual increase in light intensity of a selected light source that faces a location of the user holding the electronic device; and
activates, to capture the image, a corresponding one of the at least one front camera and the at least one back camera that has a field of view of the position of the user.

12. The electronic device of claim 1, wherein the controller:
following completion of the capture of the image, reduces a level of the light source back to an initial level from before initiation of the image recognition authentication.

13. A method comprising:
detecting an unlock trigger event while an electronic device is in a locked state, the unlock trigger event activating an image recognition authentication module which configures the electronic device to perform image recognition to unlock the electronic device;
detecting, using a light sensor, a LUX value of ambient light in a space in which the electronic device is located; and
in response to the LUX value of the ambient light being below a threshold LUX value required to support 2D facial recognition:
activating a light source of the electronic device to project light into a field of view of at least one camera of the electronic device, the projected light increasing the LUX value of light detectable from an image captured within the field of view;
activating a first one of the at least one camera to capture the image within the field of view; and
unlocking the electronic device for access by a user, in response to the captured image matching a stored image of an authentication token for the electronic device.

14. The method of claim 13, wherein the light source comprises a backlight of a display of the electronic device, and the method comprises activating the backlight at a low luminance level and gradually increasing a luminance of the backlight to increase a brightness of the display until an amount of light projected enables capture of the image with sufficient clarity to complete the image recognition for login authentication.

15. The method of claim 13, wherein the light source comprises a flashlight, and the method comprises activating the flashlight at a low luminance level and gradually increasing a luminance of the flashlight to enable capture of the image with sufficient clarity to complete the image recognition for login authentication.

16. The method of claim 13, wherein the authentication token is an image of a face of an authenticated user, and the captured image is a face of a user attempting to access the electronic device, wherein further the method comprises unlocking the electronic device for access by a user, in response to the captured image of the face of the user matching a stored image of the face of the authenticated user.

17. The method of claim 13, further comprising:
identifying, from received sensor inputs, a position of a user holding the electronic device relative to a front and a back side of the electronic device, the electronic device comprising at least one front camera and at least one back camera and at least one front facing light source and at least one back facing light source;
performing a gradual increase in light intensity of a selected light source that faces a location of the user holding the electronic device; and
activating, to capture the image, a corresponding one of the at least one front camera and the at least one back camera that has a field of view of the position of the user.

18. The method of claim 13, further comprising:
following completion of the capture of the image, reducing a level of the light source back to an initial level from before initiation of the image recognition authentication.

19. A computer program product comprising:
a non-transitory computer readable storage device; and
program code on the computer readable storage device that when executed by a controller associated with an electronic device, the program code configures the controller to cause the electronic device to provide functionality of:
detecting an unlock trigger event while an electronic device is in a locked state, the unlock trigger event activating an image recognition authentication module which configures the electronic device to perform image recognition to unlock the electronic device;
detecting, using a light sensor, a LUX value of ambient light in a space in which the electronic device is located; and
in response to the LUX value of the ambient light being below a threshold LUX value required to support 2D facial recognition:
activating a light source of the electronic device to project light into a field of view of at least one camera of the electronic device, the projected light increasing the LUX value of light detectable from an image captured within the field of view;
activating a first one of the at least one camera to capture the image within the field of view; and
unlocking the electronic device for access by a user, in response to the captured image matching a stored image of an authentication token for the electronic device.

20. The computer program product of claim 19, wherein the light source comprises a backlight of a display of the electronic device and wherein the program code configures the controller to cause the electronic device to provide functionality of activating the backlight at a low luminance level and gradually increasing a luminance of the backlight to increase a brightness of the display until an amount of light projected enables capture of the image with sufficient clarity to complete the image recognition for login authentication.
